(19) United States
(12) Patent Application Publication
(10) Pub. No.: US 2026/0365060 A1
(43) Pub. Date: Nov. 19, 2026

(54) CHARGER AND A COMMUNICATION METHOD THEREOF

(71) Applicants: HYUNDAI MOTOR COMPANY, Seoul (KR); KIA CORPORATION, Seoul (KR); Kyungshin Corp., Incheon (KR)

(72) Inventors: Yun Jae Jung, Hwaseong-si (KR); Wang Yong Lee, Bucheon-si (KR); Chung Gun Hong, Siheung-si (KR)

(73) Assignees: HYUNDAI MOTOR COMPANY, Seoul (KR); KIA CORPORATION, Seoul (KR); Kyungshin Corp., Incheon (KR)

(21) Appl. No.: 19/388,430

(22) Filed: Nov. 13, 2025

(30) Foreign Application Priority Data
May 13, 2025 (KR) 10-2025-0062096

(51) Int. Cl. B60L 53/60; B60L 53/30; G06F 8/65

(52) U.S. Cl. CPC B60L 53/60; B60L 53/305; G06F 8/65

(57) ABSTRACT

A charger and a communication method enable a charger to perform communication via a communication port. The communication method includes switching an operation mode of the charger between a first mode for a charging operation and a second mode for enabling the charger to perform communication with an external terminal based on whether an input pattern of a user button matches with a predetermined pattern. The method further includes opening or closing a switch between a terminal provided by an outlet and a communication port for communication with the external terminal. The method further includes enabling the charger to perform communication with the external terminal via the communication port.

### CROSS-REFERENCE TO THE RELATED APPLICATION

This application claims the benefit of and priority to Korean Patent Application No. 10-2025-0062096, filed on May 13, 2025, in the Korean Intellectual Property Office, the disclosure of which is incorporated herein by reference in its entirety.

### TECHNICAL FIELD

The present disclosure relates to a charger and a communication method thereof.

### BACKGROUND

In recent times, there has been an abrupt increase in the integration of in-cable control boxes (ICCB) offering minimal spatial limitations and user convenience by allowing slow charging of electric vehicles (EV)s at locations where dedicated charging stations are unavailable. Consequently, alongside national standards and policies, the need for software (SW) updates to manage slow charging systems has been gradually growing.

Conventional software update methods require disassembling an outer body of the ICCB, updating the software, and then reassembling the outer body of the ICCB. This process is cumbersome and may potentially reduce liquid ingress protection of the ICCB.

To solve such problems, a technology in which a line-in (LIN) transceiver is equipped in a controller included in a conventional ICCB and software of the ICCB is updated through an external update device has been developed. In this technology, however, manufacturing requirements of the resultant portable charger may increase because the separate external device for software update should be provided and the LIN transceiver should be installed in the ICCB.

The above matters disclosed in this section are merely for enhancement of understanding of the general background of the disclosure and should not be taken as an acknowledgement or any form of suggestion that the matters form the related art already known to a person of ordinary skill in the art.

### SUMMARY OF THE DISCLOSURE

The present disclosure provides a technical solution by providing technology capable of updating software of a charger without requiring disassembling an external body of the charger, without requiring a separate external device for updates, and without requiring installation of a separate transceiver in the charger.

The present disclosure relates to technology for updating software of a charger, e.g., a vehicle charger without using a separate software update module.

An aspect of the present disclosure is to provide a technical solution capable of updating software of a charger for a vehicle without disassembling the external body of the charger.

Another aspect of the present disclosure is to provide a technical solution capable of updating software of a charger for a vehicle without the need for a separate external device for update.

Another aspect of the present disclosure is to provide a technical solution capable of updating software of a charger for a vehicle without installation of a separate transceiver in the charger.

Aspects of the present disclosure are not limited to the above-described aspect. Other aspects of the present disclosure not yet described should be more clearly understood by those of ordinary skill in the art from the following detailed description.

In accordance with the present disclosure, the above and other aspects may be accomplished by the provision of a communication method of a charger, e.g., a vehicle charger. The method includes switching an operation mode of the charger between a first mode for a charging operation and a second mode for enabling the charger to perform communication with an external terminal based on whether an input pattern of a user button matches with a predetermined pattern. The method further comprises opening or closing a switch between a terminal provided by an outlet and a communication port for communication with the external terminal. The method further comprises enabling the charger to perform communication with the external terminal via the communication port.

Opening or closing the switch may include closing the switch based on the input pattern matching with the predetermined pattern.

Opening or closing the switch may include opening the switch based on the input pattern not matching with the predetermined pattern.

Opening or closing the switch may be carried out based on an output value of an input/output port connected to the switch.

Opening or closing the switch may include outputting a ‘High’ signal through the input/output port based on the input pattern matching with the predetermined pattern.

Opening or closing the switch may include outputting a ‘Low’ signal through the input/output port based on the input pattern not matching with the predetermined pattern.

Opening or closing the switch may include deactivating all ports configured to monitor a voltage of a line connected to the terminal, based on the input pattern matching with the predetermined pattern.

Opening or closing the switch may include activating all ports configured to monitor a voltage of a line connected to the terminal based on the input pattern not matching with the predetermined pattern.

Opening or closing the switch may include generating a predetermined pulse signal and outputting the generated pulse signal to a line connected to the terminal based on the input pattern not matching with the predetermined pattern.

The communication method may further include displaying an update status of the charger by controlling a display unit.

In accordance with another aspect of the present disclosure, there is provided a charger, e.g., a vehicle charger. The charger includes an outlet including a communication line terminal and a plurality of power terminals. The charger further includes a manipulator configured to receive a command from a user. The charger further includes a controller including a data receiving port and configured to selectively perform, based on a command input through the manipulator, a first mode operation of disconnecting the data receiving port from the communication line terminal and exchanging, through the communication line terminal, a charging control signal with a device to be charged and a second mode operation of connecting the data receiving port to the communication line terminal and receiving data from an external device connected to the charger via the outlet.

The charger may further include a switch configured to selectively connect the data receiving port to the communication line terminal.

The controller may be further configured to close the switch based on an input pattern of the command not matching with a predetermined pattern.

The controller may be further configured to open the switch based on an input pattern of the command matching with a predetermined pattern.

The controller may be further configured to open or close the switch based on an output value of an input/output port connected to the switch.

The communication line terminal may include a control pilot (CP) line terminal.

The controller may be further configured to deactivate all ports configured to monitor a voltage of a line connected to the terminal, based on an input pattern of the command matching with a predetermined pattern.

The controller may be further configured to activate all ports configured to monitor a voltage of a line connected to the terminal, based on an input pattern of the command not matching with a predetermined pattern.

The controller may generate a predetermined pulse signal and output the generated pulse signal to a line connected to the terminal, based on an input pattern of the command not matching with the predetermined pattern.

The charger may further include a display configured to display an update status of the charger.

In accordance with various embodiments of the present disclosure described above, the software of the vehicle charger may be updated without disassembling the external body. Accordingly, the update process may be simple, and liquid ingress protection may be maintained.

Additionally, the software of the vehicle charger may be updated without requiring a separate external device for update. Accordingly, hardware requirements may be reduced.

Furthermore, the software of the vehicle charger may be updated without installation of a separate transceiver in the charger. Accordingly, the circuit of the vehicle charger may be simple, and hardware requirements may be reduced.

Effects attainable in the present disclosure are not limited to the above-described effects. Other effects of the present disclosure not yet described should be more clearly understood by those of ordinary skill in the art from the following description.

### BRIEF DESCRIPTION OF THE DRAWINGS

The above and other aspects, features and other advantages of the present disclosure should be more clearly understood from the following detailed description taken in conjunction with the accompanying drawings, in which:

FIG. 1 is a schematic diagram depicting a configuration of a communication system according to an embodiment;

FIG. 2 is a schematic diagram depicting a configuration of a vehicle charger;

FIG. 3 is a schematic diagram depicting configurations of terminals of an outlet;

FIG. 4 is a diagram depicting operations of a controller and a switch in a first mode;

FIG. 5 is a diagram depicting a voltage measured through a control pilot (CP) line in the first mode;

FIG. 6 is a diagram depicting operations of the controller and the switch in a second mode;

FIG. 7 is a diagram depicting a voltage measured through the control pilot (CP) line in the second mode;

FIG. 8 is a schematic diagram depicting a configuration of a display unit; and

FIG. 9 is a flowchart depicting a communication method according to an embodiment.

### DETAILED DESCRIPTION

In the present disclosure disclosed herein, specific structural or functional descriptions describe various embodiments of the present disclosure. The embodiments of the present disclosure may be implemented in various forms and should not be interpreted as being limited to the embodiments described in the present specification.

As various modifications may be made and diverse embodiments are applicable to the embodiments according to the concept of the present disclosure, specific embodiments are illustrated with reference to the accompanying drawings and described in detail herein. However, these embodiments should not be construed as limiting according to the concept of the present disclosure, but should be construed as extending to all modifications, equivalents, and substitutes included in the concept and technological scope of the disclosure.

Unless defined otherwise, terms used herein including technological or scientific terms have the same meaning as commonly understood by those of ordinary skill in the art to which the disclosure pertains. Such terms as those defined in a generally used dictionary may be interpreted as having meanings consistent with the context of the relevant field of art and should not be interpreted to have ideal or overly formal meanings unless explicitly defined in the present disclosure.

Hereinafter, embodiments of the present disclosure are described in detail with reference to the accompanying drawings. Identical or equivalent elements are designated by the same reference numerals regardless of the numerals in the drawings and redundant description thereof is omitted.

In the following description of embodiments, the term “predetermined” means that, when a parameter is used in a process or an algorithm, the numerical value of the parameter has been previously determined. The numerical value of the parameter may be set when the process or the algorithm is initialized or during a period in which the process or algorithm is executed in accordance with an embodiment.

The suffixes “module” and “unit” of elements herein are used for convenience of description and thus may be used interchangeably and do not have any distinguishable meanings or functions.

In the following description of the embodiments of the present disclosure, a detailed description of known functions and configurations incorporated herein are omitted when it may obscure the subject matter of the embodiments of the present disclosure. In addition, the embodiments of the present disclosure should be more clearly understood from the accompanying drawings and should not be limited by the accompanying drawings. It should be appreciated that all changes, equivalents, and substitutes that do not depart from the spirit and technical scope of the present disclosure are encompassed in the present disclosure.

It should be understood that, although the terms “first,” “second,” and the like may be used herein to describe various elements. These elements should not be limited by these terms. These terms are only used to distinguish one element from another.

When an element or a component is described as “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

Unless clearly used otherwise, singular expressions include a plural meaning.

In this specification, the term “comprising,” “including,” or the like, is intended to express the existence of the characteristic, the numeral, the step, the operation, the element, the part, or the combination thereof, and does not exclude another characteristic, numeral, step, operation, element, part, or any combination thereof, or any addition thereto.

When a component, device, element, or the like of the present disclosure is described as having a purpose or performing an operation, function, or the like, the component, device, or element should be considered herein as being “configured to” meet that purpose or perform that operation or function.

For example, a “processor configured to (or set to) perform A, B, and C” may mean a dedicated processor (e.g., an embedded processor) for performing a corresponding operation or a specifically configured processor (e.g., a central processing unit (CPU) or an application processor) which performs corresponding operations by executing one or more software programs or computer-executable instructions which are stored in a memory device. The terms used in the specification are only used to describe a specific embodiment and are not intended to limit the scope of the present disclosure. In particular, each “part”, “unit”, “module”, “component”, “device”, “element”, and the like may separately embody or be included with a processor and a memory, such as a non-transitory computer readable media, as part of the apparatus.

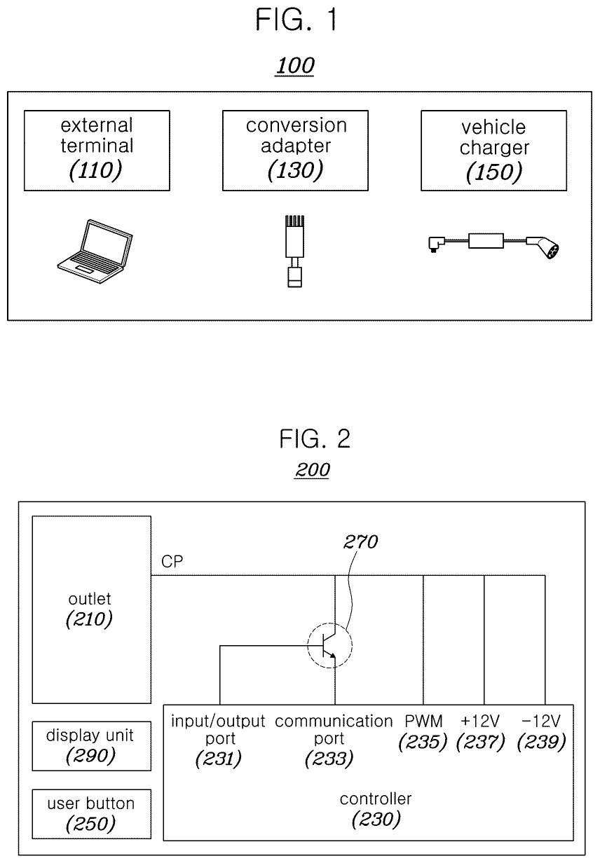

FIG. 1 is a diagram depicting a configuration of a communication system according to an embodiment.

Referring to FIG. 1, a communication system 100 according to this embodiment includes an external terminal 110, a conversion adapter 130, and a charger, e.g., a vehicle charger 150.

The external terminal 110 is a device configured to perform communication with the vehicle charger 150. For example, the external terminal 110 may transmit data for software update to the vehicle charger 150.

The external terminal 110 may be any of various terminals such as smartphones, portable terminals, mobile terminals, foldable terminals, personal digital assistants (PDAs), portable multimedia players (PMPs), telematics devices, navigation devices, personal computers, laptops, slate PCs, tablets, ultrabooks, wearable devices (e.g., smartwatches, smart glasses, head-mounted displays, etc.), WiBro terminals, internet protocol television (IPTV) devices, smart TVs, digital broadcasting terminals, audio/video navigation (AVN) devices, audio/video (AV) systems, flexible terminals, digital signage devices, and the like.

The conversion adapter 130 is an interface device configured to enable data transmission and connection between the external terminal 110 and the vehicle charger 150.

In this case, the conversion adapter 130 may be connected to the external terminal 110 via a terminal configured to provide connection to the external terminal 110, for example, a universal serial bus (USB) port. The conversion adapter 130 may be connected to an outlet or port of the vehicle charger 150 to perform a function such as a software update.

The conversion adapter 130 described above functions as a small hardware module for data communication, providing smooth connection between systems.

In this case, the conversion adapter 130 may convert a communication protocol provided by the external terminal 110 into a communication protocol supported by the vehicle charger 150 and, as such, may transmit data.

For example, the communication protocol provided by the external terminal 110 may be a universal serial bus (USB), whereas the communication protocol supported by the vehicle charger 150 may be a universal asynchronous receiver-transmitter (UART) serial communication.

The vehicle charger 150 is connected to the external terminal 110 to transmit and receive data.

For example, the vehicle charger 150 may receive data for software update from the external terminal 110.

The configuration of the vehicle charger 150 for communication with the external terminal 110 is described in detail below.

FIG. 2 is a schematic diagram depicting a configuration of a charger, e.g., the vehicle charger shown in FIG. 1.

Referring to FIG. 2, a vehicle charger 200 includes an outlet 210, a controller 230, a user button 250, a switch 270, and a display unit 290.

The outlet 210 provides a terminal capable of performing communication with the external terminal 110.

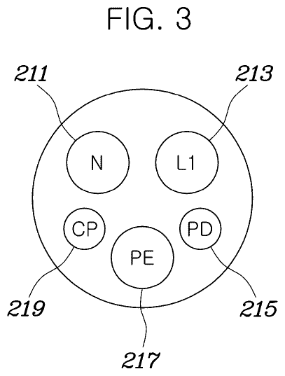

FIG. 3 is a schematic diagram depicting configurations of terminals of the outlet 210 shown in FIG. 1.

Referring to FIG. 3, the outlet 210 may be equipped with, i.e., include, five terminals including a neutral (N) terminal 211, a line-1 (L1) terminal 213, a proximity detection (PD) terminal 215, a protective earth (PE) terminal 217, and a control pilot (CP) line terminal 219. The CP line terminal 219, which may transmit a control signal, may be connected to the conversion adapter 130 to be used to perform communication with the external terminal 110.

Referring to FIG. 2, the controller 230 monitors an input including an input pattern received from the user button 250. When the input pattern received from the user button 250 is matched with a predetermined pattern for entrance to a software update mode, the controller 230 switches an operation mode of the vehicle charger 200 from a first mode to a second mode.

In this case, the first mode is defined as a general mode for a normal charging operation. The second mode is defined as an update mode in which the vehicle charger 200 performs communication with the external terminal 110 for a software update.

In the second mode, the controller 230 may close the switch 270, may activate a communication port 233 for communication with the external terminal 110, and may display an update-in-progress message on the display unit 290.

In this case, the communication port 233 may be a universal asynchronous receiver-transmitter receiver (UART RX) port capable of receiving data according to a UART communication standard.

In this case, the controller 230 may control opening and closing of the switch 270 based on an output value of an input/output port 231 connected to the switch 270.

In this case, the controller 230 may be a microcontroller unit (MCU).

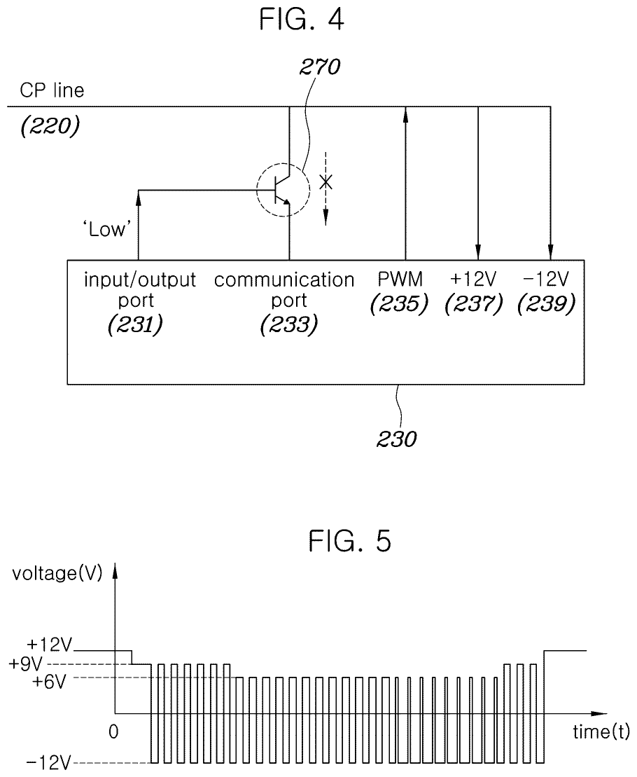

Hereinafter, respective operations of the controller 230 in the first mode and the second mode are described through comparison thereof with a voltage of the control pilot (CP) line 220, with reference to FIGS. 4-7.

Here, the CP line 220 represents a line electrically connected to the CP line terminal 219 shown in FIG. 3.

Referring to FIG. 4, in the first mode, the controller 230 outputs a ‘Low’ signal through the input/output port 231.

In this case, the input/output port 231 may be a specially configured input/output (GPIO) port.

In this case, when the ‘Low’ signal is output through the input/output port 231, the switch 270 is opened and, as such, no CP voltage is received at the communication port 233.

The controller 230 monitors a CP voltage through a +12V port 237 and a −12V port 239 intended for monitoring of the CP voltage. When charging begins, the controller 230 generates a predetermined pulse signal and outputs the generated pulse signal through a PWM port 235.

In this case, the pulse signal output through the PWM port 235 may be transmitted to the CP line 220.

In this case, a voltage between +12V and −12V may be measured on the CP line 220, as shown in FIG. 5.

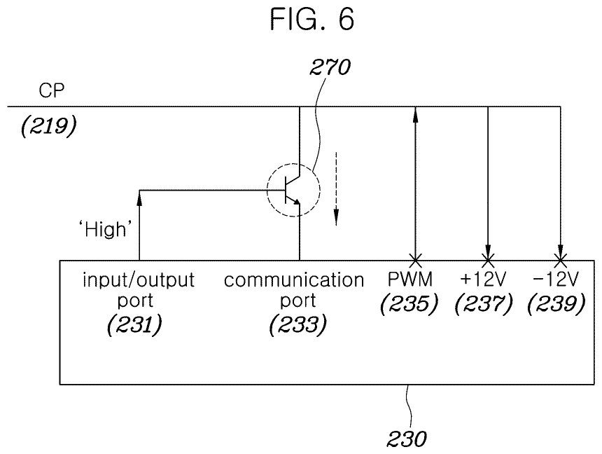

Referring to FIG. 6, in the second mode, the controller 230 outputs a ‘High’ signal through the input/output port 231.

In this case, when the ‘High’ signal is output through the input/output port 231, the switch 270 is closed and, as such, the CP voltage is received at the communication port 233.

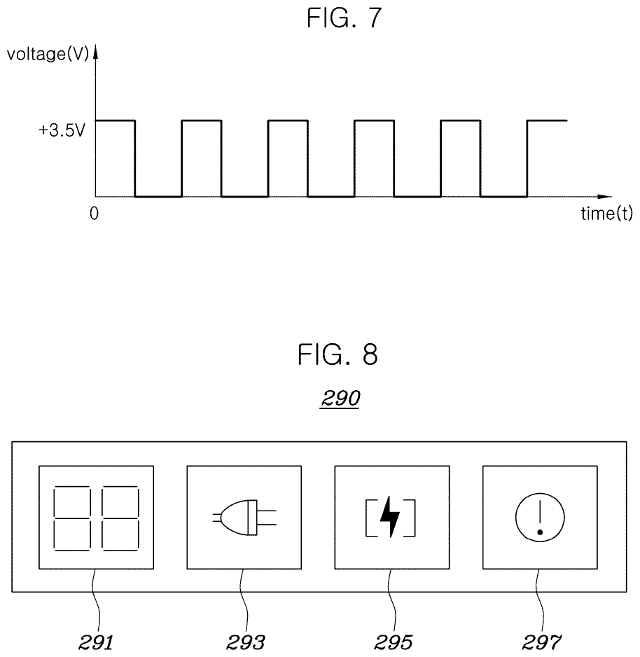

In this case, a voltage between +3.5V and 0V may be measured on the CP line 220, as shown in FIG. 7.

The controller 230 deactivates the +12V port 237 and the −12V port 239 for monitoring of the CP voltage, and the PWM port 235 that outputs the pulse signal.

Referring again to FIG. 2, the user button 250 provides an interface for enabling the user to switch the operation mode between the first mode and the second mode.

In an embodiment, the user button 250 may provide an interface configured to receive a button input from the user and, as such, may transmit a pattern of the button input to the controller 230.

In this case, the pattern of the button input may be defined as a user command, and the user button 250 may also be referred to as a manipulator that receives a user command.

In this case, the controller 230 monitors an input from the user button 250. When the input pattern of the user button 250 is matched with a predetermined pattern for entrance to the software update mode, the controller 230 may enable the vehicle charger 200 to enter the second mode.

The switch 270 opens or closes connection between the CP line 220 and the communication port 233 based on a signal output from GPIO 231 under control of the controller 230.

In this case, the switch 270 may be a transistor (TR) switch.

In an embodiment, when a ‘Low’ signal is output through the input/output port 231, the switch 270 is opened, whereas, when a ‘High’ signal is output through the input/output port 231, the switch 270 is closed.

The display unit 290 visualizes and displays a software update status of the vehicle charger 200.

In this case, the software update status of the vehicle charger 200 may include a first state, a second state, and a third state.

In this case, the first state represents an update standby state, the second state represents an update-in-progress state, and the third state represents an update failure state.

In this case, the update standby state means a state in which the user has input a predetermined input pattern for entrance to the software update mode through the user button 250, thereby causing the vehicle charger 200 to be switched to the first mode, and the vehicle charger 200 is waiting to receive data transmitted from the external terminal 110.

In this case, the update-in-progress state may mean a state in which, in the first mode, the vehicle charger 200 is receiving data from the external terminal 110.

In this case, the update failure state means a state in which, in the first mode, the software of the vehicle charger 200 cannot be updated due to various reasons, such as connection of an incorrect device to the outlet 210, reception of incorrect data from the external terminal 110, or other issues.

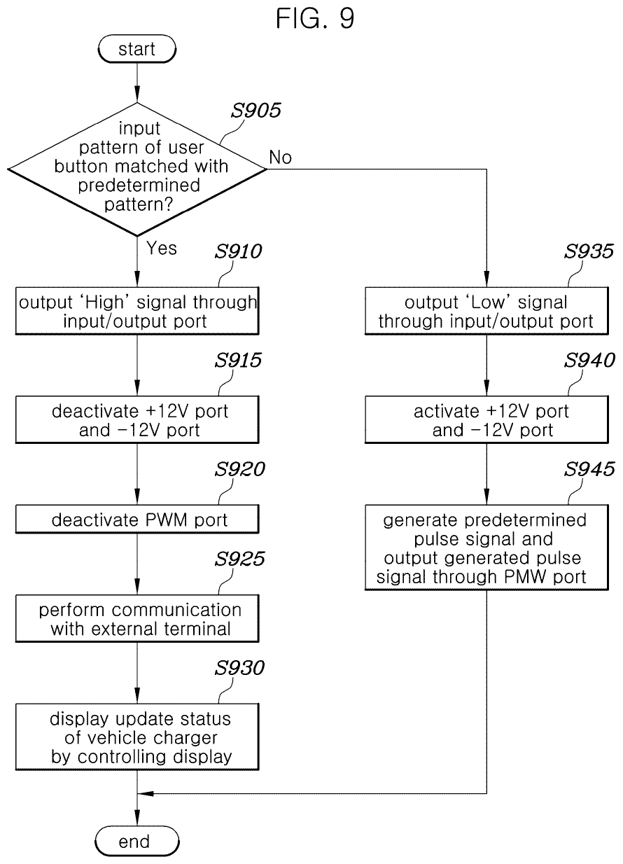

In an embodiment, as shown in FIG. 8, the display unit 290 may include a numeric display 291, a power indicator 293, a charging status indicator 295, and an error indicator 297.

In this case, the numeric display 291, the power indicator 293, the charging status indicator 295, and the error indicator 297 may all be constituted by light emitting diodes (LEDs).

In this case, the numeric display 291 may be a flexible numeric display (FND), for example, an FND configured to display two-digit numbers.

In this case, the display unit 290 may display an update status using the numeric display 291, the power indicator 293, the charging status indicator 295, and the error indicator 297.

In an embodiment, in the first state, the numeric display 291 displays ‘--’, the power indicator 293 is deactivated, and the charging status indicator 295 and the error indicator 297 may be turned on.

Additionally, in the second state, the ‘--’ display on the numeric display 291, along with the power indicator 293, the charging status indicator 295, and the error indicator 297, may all blink periodically at a predetermined interval.

Additionally, in the third state, an ‘FF’ display on the numeric display 291, along with the power indicator 293, the charging status indicator 295, and the error indicator 297, may all blink periodically at a predetermined interval.

FIG. 9 is a flow diagram depicting a communication method of the vehicle charger according to an embodiment.

The method of this embodiment may be performed by the controller 230 of FIG. 2.

Referring to FIG. 9, the controller 230 determines whether an input pattern of the user button 250 is matched with a predetermined pattern for software update (S905). Based on the input pattern matching with the predetermined input pattern (YES in S905), the controller 230 outputs a ‘High’ signal through the input/output port 231 (S910), deactivates both the +12V port 237 and the −12V port 239 for monitoring of a CP voltage (S915), and deactivates the PWM port 235 (S920).

Additionally, the controller 230 communicates with the external terminal 110 via the communication port 233 (S925).

Additionally, the controller 230 controls the display unit 290 to display a software update status of the vehicle charger 200 (S930).

On the other hand, based on the input pattern of the user button 250 not matching with the predetermined pattern in accordance with results of the determination in step S905 (NO in S905), the controller 230 outputs a ‘Low’ signal through the input/output port 231 (S935), activates both the +12V port 237 and the −12V port 239 for monitoring of the CP voltage (S940), and generates a predetermined pulse signal and outputs the generated pulse signal through the PWM port 235 (S945).

In accordance with the embodiments described above, the software of the vehicle charger may be updated without disassembling the external body. Accordingly, the update process may be simple, and liquid ingress protection may be maintained.

Additionally, the software of the vehicle charger may be updated without requiring a separate external device. Accordingly, additional hardware requirements are reduced.

Furthermore, the software of the vehicle charger may be updated without installation of a separate transceiver in the charger. Accordingly, the circuit of the vehicle charger may be simple.

The above-described embodiments may be implemented by a processor configured to execute computer-executable instructions stored in a non-transitory memory or a non-transitory computer-readable. In various embodiments, the non-transitory memory or computer-readable medium is configured to store a program recorded thereon. The program is configured to direct the processor to perform the different functions and features described above. The recording medium that may be read by a computer includes all kinds of recording media, on which data that may be read by a computer system is written. Examples of recording media that may be read by a computer may be a hard disk drive (HDD), a solid state drive (SSD), a silicon disk drive (SDD), a read only memory (ROM), a random access memory (RAM), a CD-ROM, a magnetic tape, a floppy disk, an optical data storage, and the like. Therefore, the above detailed description should be understood as an embodiment rather than limiting in all aspects. The scope of the present disclosure should also be interpreted by the claims below. All modifications as would be derived from the equivalent concept intended to be included within the scope of the present disclosure should also be interpreted as falling within the scope of the disclosure.

Although various embodiments of the present disclosure have been disclosed for illustrative purposes, those of ordinary skill in the art should appreciate that various modifications, additions and substitutions are possible, without departing from the scope and spirit of the disclosure as disclosed in the accompanying claims.

What is claimed is:

1. A communication method comprising:
switching an operation mode of a charger between a first mode for a charging operation and a second mode for enabling the charger to perform communication with an external terminal based on whether an input pattern received via a user button matches a predetermined pattern;
opening or closing a switch between a terminal provided by an outlet and a communication port for communication with the external terminal; and
enabling the charger to perform communication with the external terminal via the communication port.

2. The method of claim 1, wherein opening or closing the switch comprises closing the switch based on the input pattern matching with the predetermined pattern.

3. The method of claim 1, wherein opening or closing the switch comprises opening the switch based on the input pattern not matching with the predetermined pattern.

4. The method of claim 1, wherein the opening or closing the switch is carried out based on an output value of an input/output port connected to the switch.

5. The method of claim 4, wherein opening or closing the switch comprises outputting a ‘High’ signal through the input/output port based on the input pattern matching with the predetermined pattern.

6. The method of claim 4, wherein opening or closing the switch comprises outputting a ‘Low’ signal through the input/output port based on the input pattern not matching with the predetermined pattern.

7. The method of claim 1, wherein opening or closing the switch comprises deactivating all ports configured to monitor a voltage of a line connected to the terminal based on the input pattern matching with the predetermined pattern.

8. The method of claim 1, wherein opening or closing the switch comprises activating all ports configured to monitor a voltage of a line connected to the terminal based on the input pattern not matching with the predetermined pattern.

9. The method of claim 1, wherein opening or closing the switch comprises generating a predetermined pulse signal and outputting the generated pulse signal to a line connected to the terminal based on the input pattern not matching with the predetermined pattern.

10. The method of claim 1, further comprising:
displaying an update status of the charger by controlling a display unit.

11. A charger comprising:
an outlet including a communication line terminal and a plurality of power terminals;
a manipulator configured to receive a command from a user; and
a controller including a data receiving port, the controller configured to selectively perform, based on a command input through the manipulator, a first mode operation of disconnecting the data receiving port from the communication line terminal and exchanging, through the communication line terminal, a charging control signal with a device to be charged and a second mode operation of connecting the data receiving port to the communication line terminal and receiving data from an external device connected to the charger via the outlet.

12. The charger of claim 11, further comprising a switch configured to selectively connect the data receiving port to the communication line terminal.

13. The charger of claim 12, wherein the controller is further configured to close the switch based on an input pattern of the command matching with a predetermined pattern.

14. The charger of claim 12, wherein the controller is further configured to open the switch based on an input pattern of the command matching with a predetermined pattern.

15. The charger of claim 12, wherein the controller is further configured to open or close the switch based on an output value of an input/output port connected to the switch.

16. The charger of claim 11, wherein the communication line terminal comprises a control pilot (CP) line terminal.

17. The charger of claim 11, wherein the controller is further configured to deactivate all ports configured to monitor a voltage of a line connected to the terminal based on an input pattern of the command matching with a predetermined pattern.

18. The charger of claim 11, wherein the controller is further configured to activate all ports configured to monitor a voltage of a line connected to the terminal based on an input pattern of the command not matching with a predetermined pattern.

19. The charger of claim 11, wherein the controller generates a predetermined pulse signal and outputs the generated pulse signal to a line connected to the terminal based on an input pattern of the command not matching with a predetermined pattern.

20. The charger of claim 11, further comprising:
a display configured to display an update status of the charger.
